(19) United States
(12) Patent Application Publication
(10) Pub. No.: US 2024/0367548 A1
(43) Pub. Date: Nov. 7, 2024

(54) METHOD AND SYSTEM FOR EVALUATING BATTERY LOSS OF NEW ENERGY VEHICLE

(71) Applicant: SHENZHEN AUTOOL TECHNOLOGY CO., LTD., SHENZHEN (CN)

(72) Inventors: Hu XIAO, Songzi (CN); Li CAO, Shenzhen (CN)

(73) Assignee: SHENZHEN AUTOOL TECHNOLOGY CO., LTD., SHENZHEN (CN)

(21) Appl. No.: 18/340,836

(22) Filed: Jun. 24, 2023

(30) Foreign Application Priority Data
May 6, 2023 (CN) 202310504666.X

(51) Int. Cl. B60L 58/16; B60L 58/12

(52) U.S. Cl. CPC B60L 58/16; B60L 58/12

(57) ABSTRACT

Disclosed herein are a method and system for evaluating the battery loss of a new energy vehicle. The method includes: Step 1, acquiring factory data of a vehicle, the initial charge electric quantity of the vehicle and the duration for full charge of the vehicle; Step 2, according to the factory data of the vehicle, calculating a theoretical duration for full charge of the vehicle at each of the electric quantity levels; and Step 3, forming a plurality of reference standards by dividing in the unit of time, making the plurality of reference standards correspond to a plurality of battery health levels, and determining the battery loss degree according to the range of the reference standard where the duration difference mean value falls. The battery loss is evaluated quantitatively by means of the decrement of the charge duration.

### CROSS-REFERENCE TO RELATED APPLICATIONS

The application claims priority to Chinese patent application No. 202310504666.X, filed on May 6, 2023, the entire contents of which are incorporated herein by reference.

### TECHNICAL FIELD

The present invention relates to the field of new energy vehicles, in particular to a method and system for evaluating the battery loss of a new energy vehicle.

### BACKGROUND

With the popularity of new energy electric vehicles, the battery losses have increasingly become the concern of vehicle owners. The problem directly caused by the battery losses is the reduction of the actual mileage of the electric vehicles under the fully-charged condition. Measuring the battery losses by means of the actual mileage is a feasible method. However, the actual mileage of the electric vehicles is also affected by road conditions, usage habits of users, etc., and there are many influence factors, so that the actual mileage is unsuitable as the single referable standard. Therefore, there is an urgent need for a method and system for evaluating the battery loss of a new energy vehicle, which are used for guiding the users to maintain batteries of the vehicles in time.

### SUMMARY

The present invention aims to at least solve one of the technical problems existing in the prior art. Therefore, the present invention provides a method and system for evaluating the battery loss of a new energy vehicle.

The technical solution used in an embodiment of the present invention to solve the technical problems is as follows: the method for evaluating the battery loss of a new energy vehicle comprises:
Step 1:
acquiring factory data of a vehicle, the initial charge electric quantity of the vehicle and the duration for full charge of the vehicle;
Step 2:
according to the factory data of the vehicle, setting the initial electric quantity of the vehicle as X %, dividing the initial electric quantity into a plurality of electric quantity levels with the increment being Y %, and calculating a theoretical duration T1 for full charge of the vehicle at each of the electric quantity levels, wherein 0<X<100, and 0<Y<100; and
calculating an actual duration T2 for full charge of the vehicle under equal charge conditions at each of the electric quantity levels, calculating a difference value T3=T2−T1 at each of the electric quantity levels according to the theoretical duration T1 and the actual duration T2, and calculating a duration difference mean value T4 of the difference values T3 for N times of charging in each statistical unit with N times of charging serving as a statistical unit; and
Step 3: forming a plurality of reference standards by dividing in the unit of time T5, making the plurality of reference standards correspond to a plurality of battery health levels, and determining the battery loss degree according to the range of the reference standard where the duration difference mean value T4 falls.

The system for evaluating the battery loss of a new energy vehicle comprises:
a data acquisition module which is configured to acquire factory data of a vehicle, the initial charge electric quantity of the vehicle and the duration for full charge of the vehicle;
a statistical analysis module which is configured to set the initial electric quantity of the vehicle as X % according to the factory data of the vehicle, to divide the initial electric quantity into a plurality of electric quantity levels with the increment being Y %, to calculate a theoretical duration T1 for full charge of the vehicle at each of the electric quantity levels, to calculate an actual duration T2 for full charge of the vehicle under equal charge conditions at each of the electric quantity levels, to calculate a difference value T3=T2−T1 at each of the electric quantity levels according to the theoretical duration T1 and the actual duration T2, and to calculate a duration difference mean value T4 of the difference values T3 for N times of charging in each statistical unit with N times of charging serving as a statistical unit, wherein 0<X<100, and 0<Y<100; and
a decision module which is configured to form a plurality of reference standards by dividing in the unit of time T5, to make the plurality of reference standards correspond to a plurality of battery health levels, and to determine the battery loss degree according to the range of the reference standard where the duration difference mean value T4 falls.

The present invention has the beneficial effects as follows: with regard to the method and system for evaluating the battery loss of the new energy vehicle, the method comprises: Step 1, acquiring the factory data of the vehicle, the initial charge electric quantity of the vehicle and the duration for full charge of the vehicle; Step 2, according to the factory data of the vehicle, setting the initial electric quantity of the vehicle as X %, dividing the initial electric quantity into the plurality of electric quantity levels with the increment being Y %, and calculating the theoretical duration T1 for full charge of the vehicle at each of the electric quantity levels, wherein 0<X<100, and 0<Y<100; and calculating the actual duration T2 for full charge of the vehicle under the equal charge conditions at each of the electric quantity levels, calculating the difference value T3=T2−T1 at each of the electric quantity levels according to the theoretical duration T1 and the actual duration T2, and calculating the duration difference mean value T4 of the difference values T3 for N times of charging in each statistical unit with N times of charging serving as the statistical unit; and Step 3, forming the plurality of reference standards by dividing in the unit of time T5, making the plurality of reference standards correspond to the plurality of battery health levels, and determining the battery loss degree according to the range of the reference standard where the duration difference mean value T4 falls. The battery loss is evaluated quantitatively by means of the decrement of the charge duration, and the method has the advantages of simplicity and directness, has the statistical significance, and is operable in practical use.

### BRIEF DESCRIPTION OF DRAWINGS

The above-mentioned and/or appended aspects and advantages of the present invention will be obvious and easy to understand by means of the descriptions of the embodiments in conjunction with the accompanying drawings below, wherein

FIG. 1 is a flow chart of a method for evaluating the battery loss of a new energy vehicle; and

FIG. 2 is a block diagram of a system for evaluating the battery loss of a new energy vehicle.

### DETAILED DESCRIPTION OF THE EMBODIMENTS

Particular embodiments of the present invention will be described in detail in this part, and preferred embodiments of the present invention are shown in the drawings. The drawings are used for supplementing the descriptions of the text of the specification with figures, so that people can directly and vividly understand each technical feature and entire technical solutions of the present invention. However, the drawings cannot be understood as limitations on the scope of protection of the present invention.

In the descriptions of the present invention, “a plurality of” means two or more, “greater than”, “less than”, “exceeding”, etc. are understood as not including the original number, and “above”, “below”, “within”, etc. are understood as including the original number. The descriptions “first” and “second” are only for the purpose of distinguishing the technical features, and cannot be understood as indicating or implying the relative importance, or implicitly indicating the number of the technical features indicated, or implicitly indicating the sequence of the technical features indicated.

In the descriptions of the present invention, it should be understood that the descriptions involving orientations, for example, orientation or position relationships indicated by terms such as “upper”, “lower”, “front”, “rear”, “left”, “right” and the like are orientation or position relationships based on the accompanying drawings, are only for the purposes of facilitating the description of the present invention and simplifying the descriptions, and do not indicate or imply that the device or element referred to must have the specific orientation or be constructed and operated in the specific orientation. Therefore, they cannot be understood as limitations on the present invention.

In the present invention, unless otherwise clearly defined, the terms “arrangement”, “mounting”, “connection” and the like should be understood in a broad sense, for example, they may be direct connection, and may also be indirect connection by means of intermediate media; they may be fixed connection, and may also be detachable connection or integrated molding; they may be mechanical connection; and they may be communication of the interiors of two elements or the interactive relationship of two elements. A person skilled in the pertinent technical field would have been able to reasonably determine the specific meanings of the above-mentioned words in the present invention in conjunction with the specific content of the technical solutions.

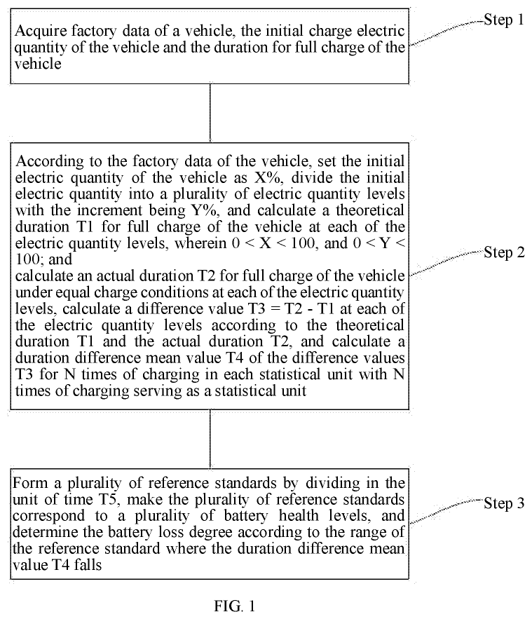

With reference to FIG. 1, a method for evaluating the battery loss of a new energy vehicle includes:
Step 1:
acquiring factory data of a vehicle, the initial charge electric quantity of the vehicle and the duration for full charge of the vehicle;
Step 2:
according to the factory data of the vehicle, setting the initial electric quantity of the vehicle as X %, dividing the initial electric quantity into a plurality of electric quantity levels with the increment being Y %, and calculating a theoretical duration T1 for full charge of the vehicle at each of the electric quantity levels, wherein 0<X<100, and 0<Y<100; and
calculating an actual duration T2 for full charge of the vehicle under equal charge conditions at each of the electric quantity levels, calculating a difference value T3=T2−T1 at each of the electric quantity levels according to the theoretical duration T1 and the actual duration T2, and calculating a duration difference mean value T4 of the difference values T3 for N times of charging in each statistical unit with N times of charging serving as a statistical unit; and
Step 3: forming a plurality of reference standards by dividing in the unit of time T5, making the plurality of reference standards correspond to a plurality of battery health levels, and determining the battery loss degree according to the range of the reference standard where the duration difference mean value T4 falls.

In the present invention, the 2023 model of BYD Han EV of 605 KW is taken as an example for illustration:
(1) firstly, acquiring the factory data of the vehicle, the initial charge electric quantity of the vehicle and the duration for full charge of the vehicle, preferably, acquiring the duration for full charge of the vehicle by means of an alternating current, which is caused by the fact that the power of direct-current charging piles has great influence, BMSs of car factories are different, the power required for charging will also affect the final duration for full charge; and
(2) then, according to the factory data of the vehicle, setting the initial electric quantity of the vehicle as 20%, dividing the initial electric quantity into 80 electric quantity levels with the increment being 1%-100%, and calculating the theoretical duration T1 for full charge of the vehicle at each of the electric quantity levels so as to obtain Table 1 (which only shows partial data):

TABLE 1

| | Initial | | |
|---|---|---|---|
| | electric | Electric quantity | Duration required for |
| Initial | quantity | required for full | full charge of 7-kW |
| SOC (%) | (72 kWh) | charge (kWh) | power (min) (T1) |
| 20 | 14.4 | 57.6 | 494 |
| 21 | 15.12 | 56.88 | 488 |
| 22 | 15.84 | 56.16 | 481 |
| 23 | 16.56 | 55.44 | 475 |
| 24 | 17.28 | 54.72 | 469 |
| 25 | 18 | 54 | 463 |
| 26 | 18.72 | 53.28 | 457 |
| 27 | 19.44 | 52.56 | 451 |
| 28 | 20.16 | 51.84 | 444 |
| 29 | 20.88 | 51.12 | 438 |
| 30 | 21.6 | 50.4 | 432 |
| . . . | . . . | . . . | . . . |

then calculating the actual duration T2 for full charge of the vehicle under equal charge conditions at each of the electric quantity levels, and calculating the difference value T3=T2−T1 at each of the electric quantity levels according to the theoretical duration T1 and the actual duration T2 so as to obtain Table 2 (which only shows partial data):

TABLE 2

| Number of | | Duration for | |
|---|---|---|---|
| times of | Initial | full charge | Difference value |
| charging | SOC (%) | (min) (T2) | T3 (min) |
| 1 | 39 | 375 | 2 |
| 2 | 42 | 357 | 1 |
| 3 | 40 | 370 | 0 |
| 4 | 49 | 310 | 5 |
| 5 | 53 | 288 | 2 |
| 6 | 66 | 206 | 4 |
| 7 | 47 | 324 | 3 |
| 8 | 70 | 187 | 1 |
| 9 | 29 | 321 | 6 |
| 10 | 61 | 239 | 2 |
| 11 | 32 | 417 | 3 |
| 12 | 25 | 460 | 4 |
| 13 | 86 | 85 | 1 |
| 14 | 73 | 163 | 4 |

calculating the duration difference mean value T4 of the difference values T3 for 10 times of charging in each statistical unit with 10 times of charging serving as the statistical unit, so as to obtain Table 3 (which only shows partial data):

TABLE 3

| | | | Difference | |
|---|---|---|---|---|
| | | | value with | Duration |
| Number of | | Duration for | theoretical | difference |
| times of | Initial | full charge | duration (min) | mean |
| charging | SOC (%) | (min) (T2) | (T3) | value T4 |
| 1 | 39 | 375 | 2 | |
| 2 | 42 | 357 | 1 | |
| 3 | 40 | 370 | 0 | |
| 4 | 49 | 310 | 5 | |
| 5 | 53 | 288 | 2 | |
| 6 | 66 | 206 | 4 | |
| 7 | 47 | 324 | 3 | |
| 8 | 70 | 187 | 1 | |
| 9 | 29 | 321 | 6 | |
| 10 | 61 | 239 | 2 | 0.2 |
| 11 | 32 | 417 | 3 | 0.3 |
| 12 | 25 | 460 | 4 | 0.4 |
| 13 | 86 | 85 | 1 | 0.1 |
| 14 | 73 | 163 | 4 | 0.4 |

(3) forming 10 reference standards by dividing in the unit of 10 min, making the reference standards correspond to 5 battery health levels, and determining the battery loss degree according to the range of the reference standard where the duration difference mean value T4 falls, so as to obtain Table 4:

TABLE 4

| Duration difference | Mileage | |
|---|---|---|
| mean value (min) (T4) | reduction (km) | Battery health evaluation |
| (0-10) | 8 | The battery capacity is |
| (10-20) | 16 | very sufficient |
| (20-30) | 24 | The battery capacity is |
| (30-40) | 32 | relatively sufficient |
| (40-50) | 40 | The battery capacity is |
| (50-60) | 48 | sufficient |
| (60-70) | 56 | There is a loss in battery |
| (70-80) | 64 | capacity |
| (80-90) | 72 | There is a significant |
| (90-100) | 80 | loss in battery capacity |

(4) the method has the advantages as follows: the battery loss is evaluated quantitatively by means of the decrement of the charge duration, and the method has the advantages of simplicity and directness, has the statistical significance, and is operable in practical use.

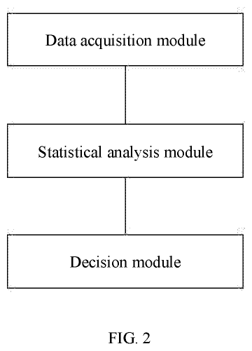

With reference to FIG. 2, a system for evaluating the battery loss of a new energy vehicle includes:
a data acquisition module which is configured to acquire factory data of a vehicle, the initial charge electric quantity of the vehicle and the duration for full charge of the vehicle;
a statistical analysis module which is configured to set the initial electric quantity of the vehicle as X % according to the factory data of the vehicle, to divide the initial electric quantity into a plurality of electric quantity levels with the increment being Y %, to calculate a theoretical duration T1 for full charge of the vehicle at each of the electric quantity levels, to calculate an actual duration T2 for full charge of the vehicle under equal charge conditions at each of the electric quantity levels, to calculate a difference value T3=T2−T1 at each of the electric quantity levels according to the theoretical duration T1 and the actual duration T2, and to calculate a duration difference mean value T4 of the difference values T3 for N times of charging in each statistical unit with N times of charging serving as a statistical unit, wherein 0<X<100, and 0<Y<100; and
a decision module which is configured to form a plurality of reference standards by dividing in the unit of time T5, to make the plurality of reference standards correspond to a plurality of battery health levels, and to determine the battery loss degree according to the range of the reference standard where the duration difference mean value T4 falls.

Of course, the present invention is not limited to the above-mentioned embodiments, a person skilled in the art would have been able to make equivalent transformations or substitutions without departing from the spirit of the present invention, and these equivalent transformations and substitutions should fall within the scope defined by the claims of the present application.

What is claimed is:

1. A method for evaluating the battery loss of a new energy vehicle, the method comprising:
Step 1:
acquiring factory data of a vehicle, the initial charge electric quantity of the vehicle and the duration for full charge of the vehicle;
Step 2:
according to the factory data of the vehicle, setting the initial electric quantity of the vehicle as X %, dividing the initial electric quantity into a plurality of electric quantity levels with the increment being Y %, and calculating a theoretical duration T1 for full charge of the vehicle at each of the electric quantity levels, wherein 0<X<100, and 0<Y<100; and
calculating an actual duration T2 for full charge of the vehicle under equal charge conditions at each of the electric quantity levels, calculating a difference value T3=T2−T1 at each of the electric quantity levels according to the theoretical duration T1 and the actual duration T2, and calculating a duration difference mean value T4 of the difference values T3 for N times of charging in each statistical unit with N times of charging serving as a statistical unit; and
Step 3:
forming a plurality of reference standards by dividing in the unit of time T5, making the plurality of reference standards correspond to a plurality of battery health levels, and determining the battery loss degree according to the range of the reference standard where the duration difference mean value T4 falls.

2. A system for evaluating the battery loss of a new energy vehicle, the system comprising:
a data acquisition module which is configured to acquire factory data of a vehicle, the initial charge electric quantity of the vehicle and the duration for full charge of the vehicle;
a statistical analysis module which is configured to set the initial electric quantity of the vehicle as X % according to the factory data of the vehicle, to divide the initial electric quantity into a plurality of electric quantity levels with the increment being Y %, to calculate a theoretical duration T1 for full charge of the vehicle at each of the electric quantity levels, to calculate an actual duration T2 for full charge of the vehicle under equal charge conditions at each of the electric quantity levels, to calculate a difference value T3=T2−T1 at each of the electric quantity levels according to the theoretical duration T1 and the actual duration T2, and to calculate a duration difference mean value T4 of the difference values T3 for N times of charging in each statistical unit with N times of charging serving as a statistical unit, wherein 0<X<100, and 0<Y<100; and
a decision module which is configured to form a plurality of reference standards by dividing in the unit of time T5, to make the plurality of reference standards correspond to a plurality of battery health levels, and to determine the battery loss degree according to the range of the reference standard where the duration difference mean value T4 falls.
